(19) United States
(12) Patent Application Publication
(10) Pub. No.: US 2010/0013782 A1
(43) Pub. Date: Jan. 21, 2010

(54) TOUCH-SENSITIVE MOBILE COMPUTING DEVICE AND CONTROLLING METHOD APPLIED THERETO

(75) Inventors: Kuan-Lin LIU, Taipei (TW); Ming-Chih HSIEH, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei, TW (TW)

(21) Appl. No.: 12/500,947

(22) Filed: Jul. 10, 2009

(30) Foreign Application Priority Data
Jul. 18, 2008 (TW) 097127482

(51) Int. Cl. G06F 3/041

(52) U.S. Cl. 345/173

(57) ABSTRACT

A touch-sensitive mobile computing device includes a main body, a display screen and a touch-sensitive interface. The touch-sensitive interface is disposed on the main body and the display screen, and includes a first touch-sensitive zone and a second touch-sensitive zone. The first touch-sensitive zone is disposed on the main body and outside the display screen. The second touch-sensitive zone is directly disposed over the display screen. A controlling method of the touch-sensitive mobile computing device includes the following steps. Firstly, the operating frame of the operating system is shown on the display screen. Then, a touch-move motion of an object in a specified direction on the first touch-sensitive zone or between the first touch-sensitive zone and the second touch-sensitive zone is detected. Afterwards, the contents of the operating frame shown on the display screen are adjusted according to the touch-move motion.

### FIELD OF THE INVENTION

The present invention relates to a touch-sensitive mobile computing device, and more particularly to a touch-sensitive mobile computing device having a function of adjusting the contents of the operating frame by a touch-move motion. The present invention also relates to a controlling method of the touch-sensitive mobile computing device.

### BACKGROUND OF THE INVENTION

Recently, the general trends in designing electronic devices are toward small size, light weightiness and easy portability. With increasing development of digital computing technologies, a mobile computing device such as a mobile phone, a personal digital assistant (PDA), a digital walkman, an e-book reader or a notebook computer has expanded functions and becomes more user-friendly.

Nowadays, mobile computing devices with touch screens or touch panels become increasingly popular because of their ease and versatility of operation. In other words, the touch screen or touch panel is a user interface between the user and the hardware components or software of the mobile computing device.

By simply touching a touch-sensitive interface of a touch screen or touch panel with a finger or a touching tool (e.g. a stylus), the user can select a function item of a menu option or a toolbar, a program file or an icon so as to execute associated functions.

Generally, the mobile computing device is executed under an operating system having a desktop environment and a graphics-based operating frame. The operating frame is shown on a display screen. In a case that the contents of the operating frame are huge, the contents of the operating frame fail to be fully browsed in a single page. For viewing the whole contents or the desired images of the operating frame, the user usually operates the directional keys of the mobile computing device to move the operating frame in the upward, downward, leftward or rightward direction.

Recently, the process of using the directional keys to control vertical or horizontal movement of the operating frame is gradually replaced by a touch-move motion on the touch-sensitive interface of the mobile computing device. The process of controlling vertical or horizontal movement of the operating frame according to the touch-move motion, however, incurs some drawbacks. For example, since the area of the display screen is limited, the finger possibly touches an icon or a function item shown on the display screen during the finger touches and moves on the touch-sensitive interface may easily touch. In other words, the operating system may discriminate that the touch-move motion is relevant to movement of the icon. Under this circumstance, an instruction contention problem occurs, and thus the operating frame fails to be moved as required.

### SUMMARY OF THE INVENTION

The present invention provides a touch-sensitive mobile computing device having a function of adjusting the contents of the operating frame without causing the instruction contention problem.

The present invention also provides a controlling method of the touch-sensitive mobile computing device.

In accordance with an aspect of the present invention, there is provided a touch-sensitive mobile computing device that is executed under an operating system. The touch-sensitive mobile computing device includes a main body, a display screen and a touch-sensitive interface. The display screen is disposed on the main body for showing an operating frame of the operating system. The touch-sensitive interface is disposed on the main body and the display screen, and includes a first touch-sensitive zone and a second touch-sensitive zone. The first touch-sensitive zone is disposed on the main body and outside the display screen. The second touch-sensitive zone is directly disposed over the display screen. When a touch-move motion of an object in a specified direction on the first touch-sensitive zone or between the first touch-sensitive zone and the second touch-sensitive zone is implemented, the contents of the operating frame shown on the display screen are adjusted.

In accordance with another aspect of the present invention, there is provided a controlling method of a touch-sensitive mobile computing device. The touch-sensitive mobile computing device is executed under an operating system, and includes a main body, a display screen and a touch-sensitive interface. The touch-sensitive interface includes a first touch-sensitive zone and a second touch-sensitive zone. The first touch-sensitive zone is disposed on the main body and outside the display screen. The second touch-sensitive zone is directly disposed over the display screen. The controlling method includes the following steps. Firstly, an operating frame of the operating system is shown on the display screen. Then, a touch-move motion of an object in a specified direction on the first touch-sensitive zone or between the first touch-sensitive zone and the second touch-sensitive zone is detected. Afterwards, the contents of the operating frame shown on the display screen are adjusted according to the touch-move motion.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic view illustrating a touch-sensitive personal digital assistant according to an embodiment of the present invention;

FIG. 1B is a schematic view illustrating an approach of controlling movement the operating frame in multiple directions according to the present invention;

FIG. 1C is a schematic view illustrating another approach of controlling movement the operating frame in multiple directions according to the present invention;

FIG. 2 is a schematic function block diagram illustrating a touch-sensitive personal digital assistant of the present invention;

FIG. 3 is a schematic view illustrating an approach of continuously controlling movement the operating frame in multiple directions according to the present invention;

FIG. 4 is a schematic view illustrating an approach of executing a page up/down function of the touch-sensitive mobile computing device according to the present invention; and

FIG. 5 schematically illustrates a flowchart of a controlling method of the touch-sensitive mobile computing device according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a touch-sensitive mobile computing device and a controlling method of the touch-sensitive mobile computing device. An example of the touch-sensitive mobile computing device includes but is not limited to a smart phone, a mobile phone, a personal digital assistant (PDA), a digital walkman, an e-book reader or a notebook computer. Hereinafter, the touch-sensitive mobile computing device is illustrated by referring to a personal digital assistant.

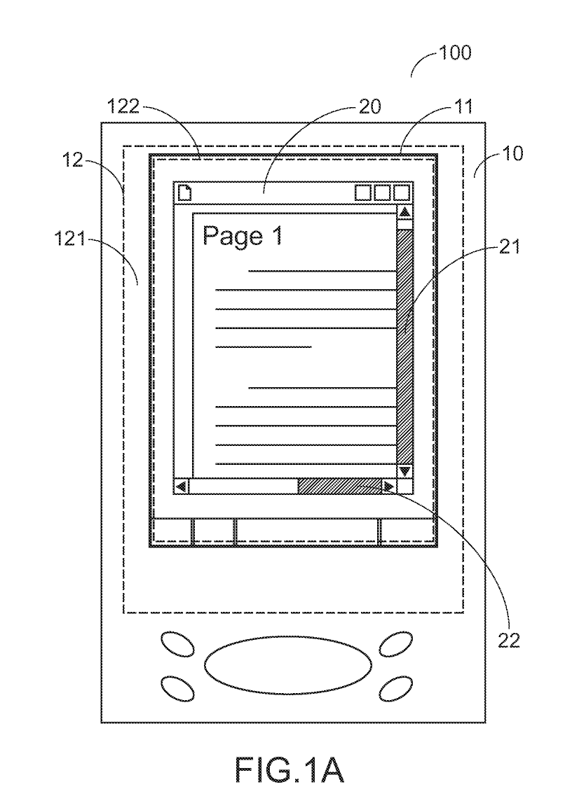

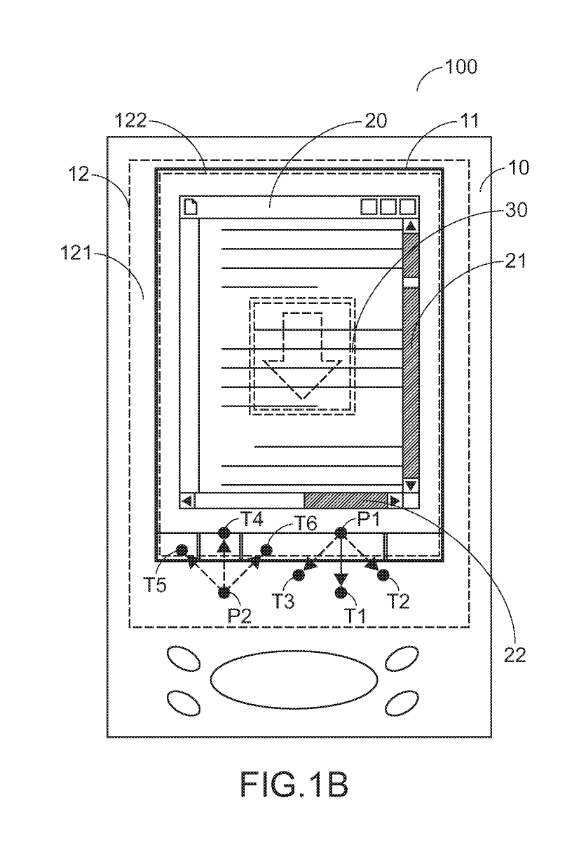

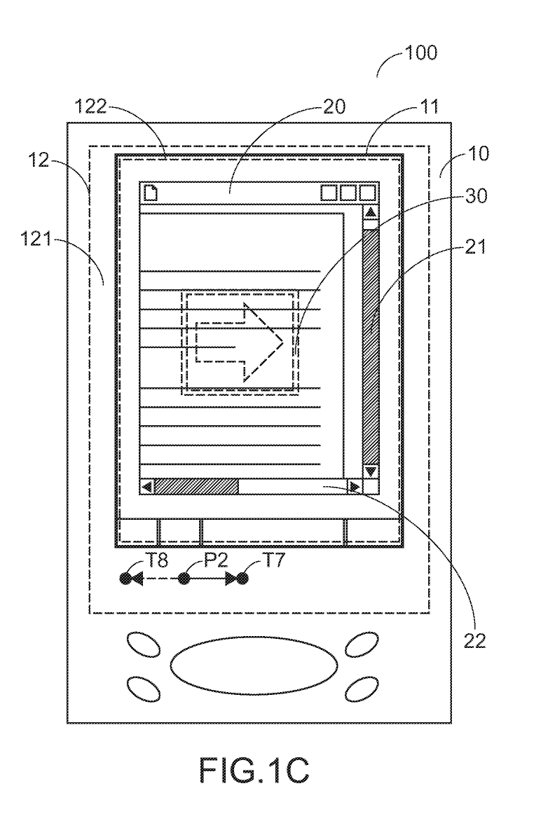

FIG. 1A is a schematic view illustrating a touch-sensitive personal digital assistant according to an embodiment of the present invention. As shown in FIG. 1A, the touch-sensitive personal digital assistant 100 comprises a main body 10, a display screen 11 and a touch-sensitive interface 12. The touch-sensitive personal digital assistant 100 is executed under an operating system having a desktop environment and a graphics-based operating frame. The display screen 11 is disposed on the main body 10 for showing an operating frame 20 running under the operating system. For example, the operating frame 20 includes the contents of function items of menu options or toolbars, or icons, which are generated by the operating system. In addition, the operating frame 20 also includes the image of a document file or an image file. In accordance with a key feature of the present invention, a portion of the touch-sensitive interface 12 is directly disposed over the display screen 11; and the other portion of the touch-sensitive interface 12 is disposed on the main body 10 and outside the display screen 11.

The touch-sensitive interface 12 is made of a transparent material. The area of the touch-sensitive interface 12 is larger than that of the display screen 11. The touch-sensitive interface 12 includes a first touch-sensitive zone 121 and a second touch-sensitive zone 122. The first touch-sensitive zone 121 is disposed on the main body 10 and outside the display screen 11. The second touch-sensitive zone 122 is directly disposed over the display screen 11 and has an area larger than the first touch-sensitive zone 121. In other words, the image shown on the display screen 11 is viewable through the second touch-sensitive zone 122.

By touching a finger or a touching tool (e.g. a stylus) on the touch-sensitive interface 12, the user can input an instruction to control operations of the touch-sensitive personal digital assistant 100. In particular, when the user's finger or the stylus touches and then moves on the first touch-sensitive zone 121 or moves between the first touch-sensitive zone 121 and the second touch-sensitive zone 122, the image shown on the display screen 11 could be scrolled, shifted or adjusted in the moving direction.

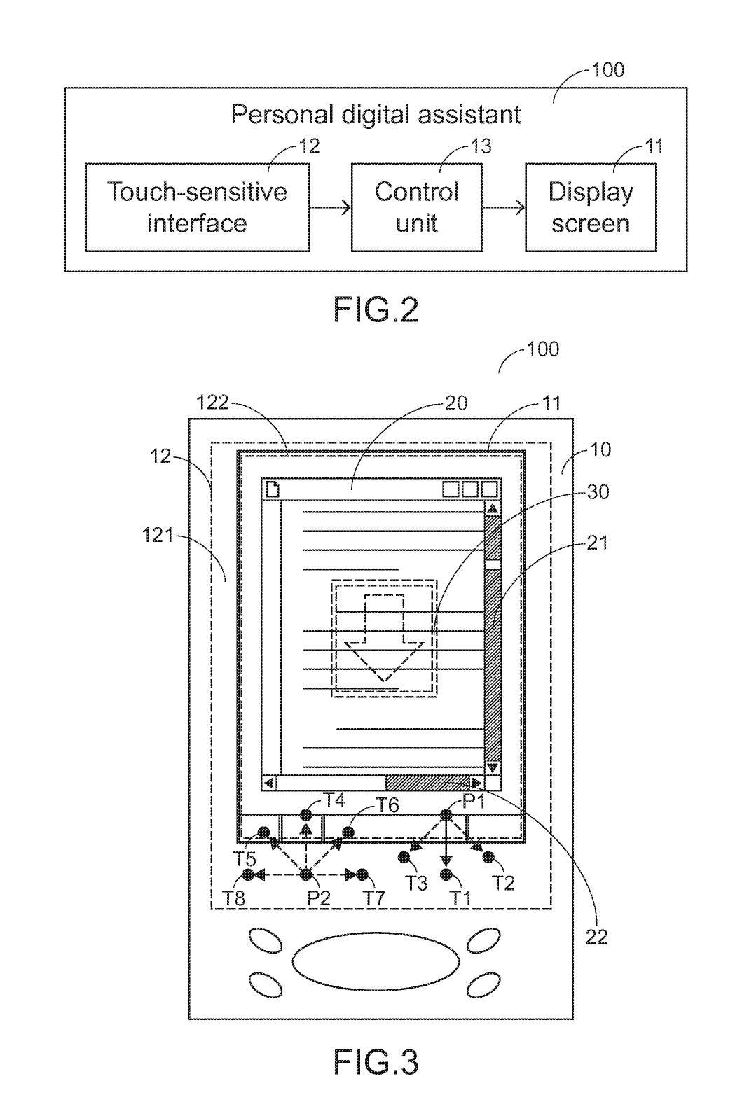

FIG. 2 is a schematic function block diagram illustrating a touch-sensitive personal digital assistant of the present invention. As shown in FIG. 2, the touch-sensitive personal digital assistant 100 further comprises a control unit 13. The control unit 13 is disposed within the main body 10 and communicates with the touch-sensitive interface 12 and the display screen 11. The control unit 13 is used for controlling operations of the touch-sensitive personal digital assistant 100 and process instructions. Via the touch-sensitive interface 12, the user can input an instruction. In response to the instruction, the control unit 13 controls the image shown on the display screen 11.

Please refer to FIG. 1A again. A vertical scrollbar 21 and a horizontal scrollbar 22 are also shown on the operating frame 20. By operating the vertical scrollbar 21 and the horizontal scrollbar 22, the image shown on the display screen 11 can be respectively moved in the vertical direction and in the horizontal direction in order to facilitate the user to view the whole contents of the operating frame 20.

FIG. 1B is a schematic view illustrating an approach of controlling movement the operating frame in multiple directions according to the present invention. As shown in FIG. 1B, there are two start touching points P1 and P2 and six end touching points T1˜T6. Since the first touch-sensitive zone 121 is outside the display screen 11, the touch-move motion of the user's finger on the first touch-sensitive zone 121 has nothing to do with the menu option, the toolbar, the program file or the icon included in the operating frame 20.

By moving the user's finger on the first touch-sensitive zone 121, the operating frame 20 could be moved in diverse directions from the start touching points to the end touching points. Since the area of the first touch-sensitive zone 121 is relatively smaller with respect to the area of the main body, the smaller-area of the first touch-sensitive zone 121 sometimes becomes hindrance from moving the user's finger. In this embodiment, the user's finger is moved between the first touch-sensitive zone 121 and the second touch-sensitive zone 122 in order to control movement of the operating frame 20. For precisely controlling movement of the operating frame 20, the start touching point and the touching point of every moving action are located on different zones of the touch-sensitive interface 12.

For example, when the user's finger moves from the start touching point P1 of the second touch-sensitive zone 122 to the end touching point T1 of the first touch-sensitive zone 121 in the direction P1T1 indicated by a solid line and then leaves the touch-sensitive interface 12, the positions of the touching points P1 and T1 are sensed by the control unit 13. As such, the operating frame 20 is controlled to be scrolled down under control of the control unit 13. For facilitating the user to realize the moving direction of the operating frame 20, a directional image 30 is also shown on the display screen 11 to prompt the user. As shown in FIG. 1B, the directional image 30 indicates a downward arrow sign. The directional image 30 is translucent and thus does not shelter the image shown on the display screen 11. Moreover, the directional image 30 appears only during the moving process of the operating frame 20.

Similarly, when the user's finger moves from the start touching point P2 of the first touch-sensitive zone 121 to the end touching point T4 of the second touch-sensitive zone 122 in the direction P2T4 indicated by a dotted line and then leaves the touch-sensitive interface 12, the positions of the touching points P2 and T4 are sensed by the control unit 13. As such, the operating frame 20 is controlled to be scrolled up under control of the control unit 13.

Similarly, when the user's finger moves from the start touching point P1 to the end touching point T2 in the direction P1T2 indicated by a dotted line and then leaves the touch-sensitive interface 12, the operating frame 20 is moved in the lower-right direction. Similarly, when the user's finger moves from the start touching point P1 to the end touching point T3 in the direction P1T3 indicated by a dotted line and then leaves the touch-sensitive interface 12, the operating frame 20 is moved in the lower-left direction. Similarly, when the user's finger moves from the start touching point P2 to the end touching point T6 in the direction P2T6 indicated by a dotted line and then leaves the touch-sensitive interface 12, the operating frame 20 is moved in the upper-right direction. Similarly, when the user's finger moves from the start touching point P2 to the end touching point T5 in the direction P2T5 indicated by a dotted line and then leaves the touch-sensitive interface 12, the operating frame 20 is moved in the upper-left direction.

FIG. 1C is a schematic view illustrating another approach of controlling movement the operating frame in multiple directions according to the present invention. In this embodiment, the operating frame 20 is scrolled in the left or right side by a touch-move motion of the user's finger. Since the area of the first touch-sensitive zone 121 is sufficient to allow horizontal motion of the user's finger, the second touch-sensitive zone 122 does not need to be touched during the process of scrolling the operating frame 20 in the left or right side. For example, when the user's finger moves from the start touching point P2 of the first touch-sensitive zone 121 to the end touching point T7 in the direction P2T7 indicated by a solid line and then leaves the touch-sensitive interface 12, the positions of the touching points P2 and T7 are sensed by the control unit 13. As such, the operating frame 20 is controlled to be scrolled in the right side under control of the control unit 13. For facilitating the user to realize the moving direction of the operating frame 20, a directional image 30 is also shown on the display screen 11 to prompt the user. As shown in FIG. 1C, the directional image 30 indicates a rightward arrow sign. The directional image 30 is translucent and thus does not shelter the image shown on the display screen 11. Moreover, the directional image 30 appears only during the moving process of the operating frame 20.

Similarly, when the user's finger moves from the start touching point P2 of the first touch-sensitive zone 121 to the end touching point T8 in the direction P2T8 indicated by a dotted line and then leaves the touch-sensitive interface 12, the positions of the touching points P2 and T8 are sensed by the control unit 13. As such, the operating frame 20 is controlled to be scrolled in the left side under control of the control unit 13.

Since the first touch-sensitive zone 121 of the touch-sensitive interface 12 is disposed on the main body 10 and outside the display screen 11, the touch-move motion of the user's finger on the first touch-sensitive zone 121 has nothing to do with the menu option, the toolbar, the program file or the icon included in the operating frame 20. In a case that the start touching point or the end touching point of each touch-move motion is located on the first touch-sensitive zone 121, the control unit 13 will discriminate that the touch-move motion is relevant to the moving, scrolling or shift action of the operating frame 20. Under this circumstance, the problem of causing instruction contention will be overcome.

In the above embodiments, the touch-move motion of the user's finger on the touch-sensitive interface 12 is similar to the operations of the vertical scrollbar 21 and the horizontal scrollbar 22. As a consequence, the whole contents of the operating frame 20 are viewable by the user. In other words, when the user's finger moves from a start touching point (P1˜P2) to an end touching point (T1˜T8) and then leaves the touch-sensitive interface 12, the operating frame 20 could be moved, shifted or scrolled by only one or several columns or rows. For moving the operating frame 20 to a larger extend, the touch-move motion in the same direction should be repeatedly done. In other word, the user's finger needs to move from the start touching point to the end touching point again and again. In views of user-friendliness and convenience, it is preferred that the operating frame 20 needs to be continuously moved.

FIG. 3 is a schematic view illustrating an approach of continuously controlling movement the operating frame in multiple directions according to the present invention. In comparison with the controlling approaches described in FIGS. 1B and 1C, the user' finger moves from the start touching point to the end touching point and then stays at the end touching point. As shown in FIG. 3, there are two start touching points P1 and P2 and eight end touching points T1˜T8. For example, when the user's finger moves from the start touching point P1 to the end touching point T1 and then stays at the end touching point T1, the operating frame 20 is continuously moved in the downward direction until the user's finger leaves the touch-sensitive interface 12. In an embodiment, after the user's finger moves from the start touching point to the end touching point and then stays at the end touching point for a certain period, the control unit 13 will control continuous movement of the operating frame 20. Correspondingly, the vertical scrollbar 21 and/or the horizontal scrollbar 22 will be scrolled to a larger extend.

Under this circumstance, the contents of the operating frame 20 could be continuously adjusted without the need of moving the user's finger from the start touching point to the end touching point again and again. It is preferred that the continuous movement of the operating frame 20 is ceased once the user's finger (or the touching tool) leaves the touch-sensitive interface 12. Similarly, a directional image 30 is also shown on the display screen 11 for facilitating the user to realize the moving direction of the operating frame 20. As shown in FIG. 3, the directional image 30 indicates a downward arrow sign. The directional image 30 is translucent and thus does not shelter the image shown on the display screen 11.

In the above embodiments, the operating frame 20 could be stepwise or continuously moved, scrolled or shifted by the touch-move motion of the user's finger (or the touching tool). In comparison with the conventional method of operating the directional keys, the present invention is more user-friendly and convenient.

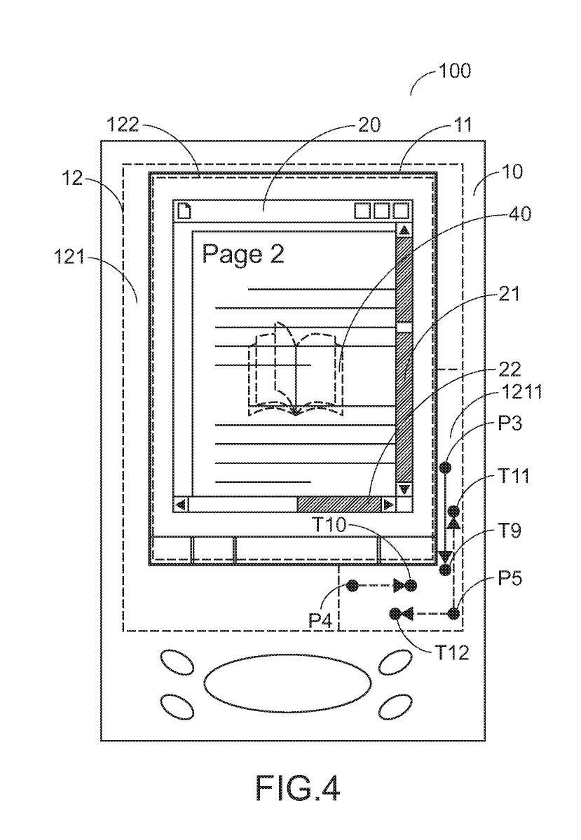

For adjusting the contents of the operating frame 20 to a greater extent, the touch-sensitive mobile computing device of the present invention further includes a “Page up/down” or “Scroll up/down” function, which is executed to have the operating frame 20 backward to the previous page or forward to the next page. FIG. 4 is a schematic view illustrating an approach of executing a page up/down function of the touch-sensitive mobile computing device according to the present invention. As shown in FIG. 4, the first touch-sensitive zone 121 includes a jumping touch-sensitive region 1211. In this embodiment, the jumping touch-sensitive region 1211 is arranged at a corner (e.g. a lower-right corner) of the display screen 11. By the touch-move motion of the user's finger (or the touching tool) on the jumping touch-sensitive region 1211, the “Page up/down” or “Scroll up/down” function of the touch-sensitive personal digital assistant 100 is executable. As shown in FIG. 4, there are three start touching points P3˜P5 and four end touching points T9˜T12 in the jumping touch-sensitive region 1211. When the user's finger moves from a start touching point (P3˜P5) to an end touching point (T9˜T12) and then leaves the touch-sensitive interface 12, the operating frame 20 could be moved, shifted or scrolled by many columns or rows or backward/forward to the previous/next page. When the user's finger moves from the start touching point P3 to the end touching point T9 and then leaves the touch-sensitive interface 12, the operating frame 20 is moved to be forward to the next page for example. Similarly, when the user's finger moves from the start touching point P4 to the end touching point T10 and then leaves the touch-sensitive interface 12, the operating frame 20 is moved in the left side to a larger extent, thereby horizontally scrolling the operating frame 20. Similarly, when the user's finger moves from the start touching point P5 to the end touching point T11 and then leaves the touch-sensitive interface 12, the operating frame 20 is moved to be backward to the previous page for example. Similarly, when the user's finger moves from the start touching point P5 to the end touching point T12 and then leaves the touch-sensitive interface 12, the operating frame 20 is moved in the right side to a larger extent, thereby horizontally scrolling the operating frame 20.

For facilitating the user to realize the moving direction of the operating frame 20, a directional image 40 is also shown on the display screen 11 to prompt the user. As shown in FIG. 4, the directional image 40 is a dynamic page up/down sign, which is displayed in a flash image. The directional image 40 is translucent and thus does not shelter the image shown on the display screen 11. Moreover, the directional image 40 appears only during the moving process of the operating frame 20.

In some embodiments, the operating frame 20 could be continuously moved. As shown in FIG. 4, there are three start touching points P3˜P5 and four end touching points T9˜T12 in the jumping touch-sensitive region 1211. When the user's finger moves from a start touching point (P3˜P5) to an end touching point (T9˜T12) and then stays at the end touching point (T9˜T12), the operating frame 20 could be continuously moved, shifted or scrolled by many columns or rows or backward/forward to the previous /next page until the user's finger leaves the jumping touch-sensitive region 1211 of the first touch-sensitive zone 121. Correspondingly, the vertical scrollbar 21 and/or the horizontal scrollbar 22 will be scrolled to a larger extend and at a faster speed.

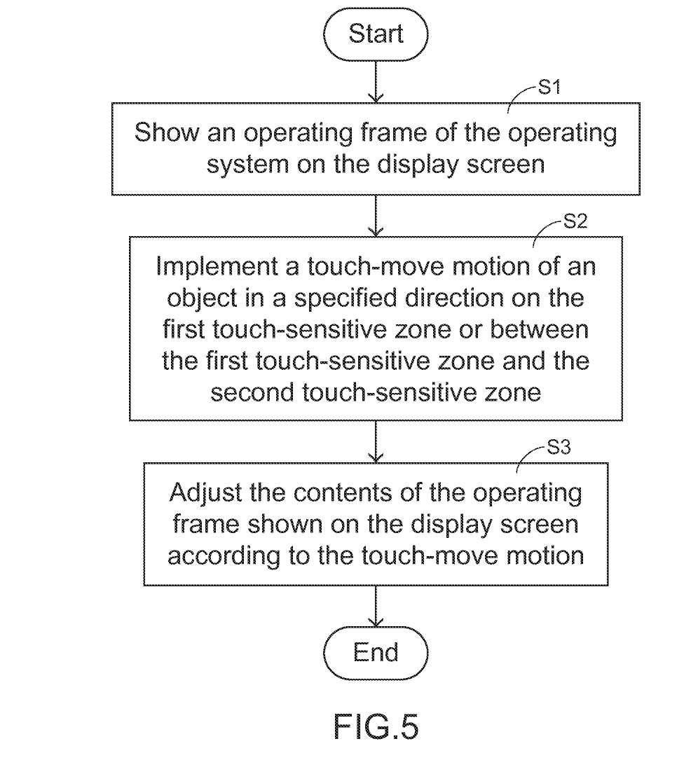

Hereinafter, a controlling method of the touch-sensitive mobile computing device of the present invention is described with reference to a flowchart of FIG. 5. Firstly, an operating frame 20 of the operating system is shown on the display screen 11 (Step S1). Then, a touch-move motion of an object (e.g. a user's finger or a stylus) in a specified direction is implemented on the first touch-sensitive zone 121 or between the first touch-sensitive zone 121 and the second touch-sensitive zone 122 (Step S2). Afterwards, the contents of the operating frame 20 shown on the display screen 11 are adjusted according to the touch-move motion (Step S3). The touch-move motion includes steps of moving the object from a start touching point to an end touching point, and then leaving the touch-sensitive interface or staying at the end touching point. As a consequence, the operating frame 20 shown on the display screen 11 is moved in the specified direction in a stepwise, continuous, stepwise-jumping or continuously-jumping manner.

In the above embodiments, the positions of the start touching points and the end touching points are illustrated by reference. Nevertheless, the positions of the start touching points and the end touching points can be determined according to the designer's or the user's settings.

From the above description, the touch-sensitive mobile computing device of the present invention is capable of adjusting the contents of the operating frame. The method of controlling vertical or horizontal movement of the operating frame by a touch-move motion on the touch-sensitive interface can replace the conventional method of operating the directional keys. Since the first touch-sensitive zone 121 is directly disposed over the display screen 11 and the second touch-sensitive zone 122 is disposed on the main body 10 and outside the display screen 11, the touch-move motion on the first touch-sensitive zone 121 or between the first touch-sensitive zone 121 and the second touch-sensitive zone 122 is independent of the touch-move motion on the second touch-sensitive zone 122 alone. Under this circumstance, the problem of causing instruction contention will be overcome. The method of controlling vertical or horizontal movement of the operating frame according to the present invention is very user-friendly and convenient.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch-sensitive mobile computing device executed under an operating system, the touch-sensitive mobile computing device comprising:
a main body;
a display screen disposed on the main body for showing an operating frame of the operating system; and
a touch-sensitive interface disposed on the main body and the display screen, and comprising a first touch-sensitive zone and a second touch-sensitive zone, wherein the first touch-sensitive zone is disposed on the main body and outside the display screen, the second touch-sensitive zone is directly disposed over the display screen, and the contents of the operating frame shown on the display screen are adjusted when a touch-move motion of an object in a specified direction is implemented on the first touch-sensitive zone or between the first touch-sensitive zone and the second touch-sensitive zone.

2. The touch-sensitive mobile computing device according to claim 1 further comprising a control unit disposed within the main body and communicating with the touch-sensitive interface for adjusting the contents of the operating frame shown on the display screen according to the touch-move motion.

3. The touch-sensitive mobile computing device according to claim 1 wherein a translucent directional image is shown on the display screen to indicate the specified direction during the contents of the operating frame shown on the display screen is adjusted.

4. The touch-sensitive mobile computing device according to claim 1 wherein the operating frame is moved in the specified direction when the object moves from a start touching point to an end touching point and then leaves the touch-sensitive interface, wherein the specified direction is defined by the start touching point and the end touching point.

5. The touch-sensitive mobile computing device according to claim 4 wherein the start touching point and the end touching point are both located on the first touch-sensitive zone of the touch-sensitive interface.

6. The touch-sensitive mobile computing device according to claim 4 wherein one of the start touching point and the end touching point is located on the first touch-sensitive zone, and the other of the start touching point and the end touching point is located on the second touch-sensitive zone.

7. The touch-sensitive mobile computing device according to claim 1 wherein the operating frame is continuously moved in the specified direction when the object moves from a start touching point to an end touching point and then staying at the end touching point, wherein the specified direction is defined by the start touching point and the end touching point.

8. The touch-sensitive mobile computing device according to claim 7 wherein the operating frame includes a vertical scrollbar and a horizontal scrollbar, and the operating frame is continuously moved in the specified direction so as to continuous scroll the vertical scrollbar or the horizontal scrollbar.

9. The touch-sensitive mobile computing device according to claim 7 wherein the start touching point and the end touching point are both located on the first touch-sensitive zone of the touch-sensitive interface.

10. The touch-sensitive mobile computing device according to claim 7 wherein one of the start touching point and the end touching point is located on the first touch-sensitive zone, and the other of the start touching point and the end touching point is located on the second touch-sensitive zone.

11. The touch-sensitive mobile computing device according to claim 7 wherein the first touch-sensitive zone further includes a jumping touch-sensitive region arranged at a corner of the display screen.

12. The touch-sensitive mobile computing device according to claim 11 wherein the operating frame is moved in the specified direction to a larger extent when the object moves from a start touching point to an end touching point and then stays at the end touching point, wherein the start touching point and the end touching point are both located on the jumping touch-sensitive region.

13. The touch-sensitive mobile computing device according to claim 12 wherein the operating frame is backward to a previous page or forward to a next page by a touch-move motion of the object on the jumping touch-sensitive region.

14. A controlling method of a touch-sensitive mobile computing device, the touch-sensitive mobile computing device being executed under an operating system and comprising a main body, a display screen and a touch-sensitive interface, the touch-sensitive interface comprising a first touch-sensitive zone and a second touch-sensitive zone, the first touch-sensitive zone being disposed on the main body and outside the display screen, the second touch-sensitive zone being directly disposed over the display screen, the controlling method comprising steps of:
showing an operating frame of the operating system on the display screen;
detecting a touch-move motion of an object in a specified direction on the first touch-sensitive zone or between the first touch-sensitive zone and the second touch-sensitive zone; and
adjusting the contents of the operating frame shown on the display screen according to the touch-move motion.

15. The controlling method according to claim 14 wherein a translucent directional image is shown on the display screen to indicate the specified direction during the contents of the operating frame shown on the display screen is adjusted.

16. The controlling method according to claim 14 further comprising steps of:
allowing the object to move from a start touching point to an end touching point and then leave the touch-sensitive interface, wherein one of the start touching point and the end touching point is located on the first touch-sensitive zone, and the other of the start touching point and the end touching point is located on the second touch-sensitive zone; and
controlling the operating frame to move in the specified direction, wherein the specified direction is defined by the start touching point and the end touching point.

17. The controlling method according to claim 14 further comprising steps of:
allowing the object to move from a start touching point to an end touching point and then stay at the end touching point, wherein at least one of the start touching point and the end touching point is located on the first touch-sensitive zone; and
controlling the operating frame to move in the specified direction, wherein the specified direction is defined by the start touching point and the end touching point.

18. The controlling method according to claim 14 wherein further comprising steps of:
allowing the object to move from a start touching point to an end touching point and then leave the touch-sensitive interface, wherein the start touching point and the end touching point are located on the first touch-sensitive zone; and
controlling the operating frame to move to a large extent in the specified direction, wherein the specified direction is defined by the start touching point and the end touching point.

19. The controlling method according to claim 18 wherein the first touch-sensitive zone further includes a jumping touch-sensitive region arranged at a corner of the display screen, and the start touching point and the end touching point are both located on the jumping touch-sensitive region.
